(19) United States
(12) Patent Application Publication
(10) Pub. No.: US 2006/0097105 A1
(43) Pub. Date: May 11, 2006

(54) Propulsion and attitude control systems for aircraft

(76) Inventors: C. Rivers Stone, Greenville, SC (US); Chad Richardson, Lawrence, KS (US); Grant Wittenborn, Olathe, KS (US); William A. Anemaat, Lawrence, KS (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/986,596

(22) Filed: Nov. 11, 2004

(51) Int. Cl. B64C 29/00

(52) U.S. Cl. 244/23 B

(57) ABSTRACT

Systems for propelling and controlling attitude of aircraft. Systems according to certain embodiments of the invention employ a fan whose rotational axis is preferably generally parallel to the yaw axis of the aircraft and which is preferably generally aligned with the center of gravity of the aircraft at least during the vertical phases of flight. Efflux from the fan can be routed downward through a vertical outlet for providing lift and vertical flight, and aft through a propulsion duct for providing thrust in horizontal flight modes. Vanes in the vertical outlet can be used to direct flow of efflux more in a forward or aft direction for “balancing” of the aircraft about the rotor in vertical flight. A vector unit located away from the center of gravity of the aircraft, such as in or near the tail of the aircraft, through which engine efflux can be routed, employs vanes to direct efflux flow, in a controllable fashion, upward, downward, port and/or starboard for commensurate control of the pitch and yaw of the aircraft.

This invention relates to systems and processes for propelling and controlling the attitude or orientation of an aircraft about its yaw, pitch and/or roll axis in vertical and horizontal flight.

### BACKGROUND

Since the dawn of aviation, designers have desired to create aircraft which featured not only a horizontal flight performance envelope that allowed superior performance, such as climb, endurance, range and speed, but also the ability to take off and land vertically in a minimum of space.

One of the first approaches involved Igor Sikorski and others who developed multiple and single rotor helicopter systems. Helicopters with their lengthy, typically variable pitch rotors, offer superior disk loading, that is they accelerate a large disc of air downwardly an incremental amount to lift the aircraft. Although this approach is advantageous because it reduces power required and consequent fuel flow rate in vertical flight as well as the effects of hot engine efflux and blast on the ground, the major performance disadvantage with helicopters generally is that at some horizontal speed, sometimes referred to as the physical maximum horizontal limiting speed, either the retreating blades no longer create sufficient lift, the advancing blades reach supersonic speeds, or both. In addition and in any event, the rotor disk physically creates drag in forward flight mode and thereby impairs the performance envelope in forward flight. Thus, helicopters generally feature inferior forward flight characteristics as compared to fixed wing aircraft having similar specific power parameters.

A second approach to combining vertical flight requirements with a superior forward flight performance envelope is represented by vectored-thrust nozzle aircraft such as the Hawker-Siddeley AV-8 “Harrier” system. These aircraft feature a number of nozzles which can be rotated under control by the pilot to vector engine efflux downward for vertical flight, in the aft direction through transition to forward flight, and aft for horizontal flight. However, the high disk loading requires considerable power in vertical flight, and therefore a high fuel flow rate with consequent performance effects on range and endurance, among other criteria. Additional disadvantages include hot efflux and blast on the ground or anything under the aircraft.

A third effort to combine superior vertical and horizontal flight characteristics is represented in the “Osprey” currently being developed by the U.S. Marine Corps. That approach uses a pair of engines cantilevered on the wing outboard of the fuselage, each of which is coupled to a sizeable propeller. The engines may be rotated about an axis that is substantially parallel to the pitch axis of the aircraft. Accordingly, for vertical flight, the engines and propellers may be tilted upward so that the propeller provides vertical thrust and for forward flight the engines are rotated forward so that the propellers provide horizontal thrust. This approach requires considerable robustness in the wing structure and thus additional weight in the aircraft which as a general philosophic matter is a necessity since the centers of vertical thrust are located away from the center of gravity of the aircraft. Additionally, although the engines are cross coupled, many believe that the failure of one engine in critical flight phases such as transition from vertical to horizontal flight can result in catastrophic failure.

Recently, turboshaft engines have become available which feature sufficiently high specific power ratios (output shaft power to weight) to allow effective coupling to a fan for providing vertical thrust in an aircraft, if done correctly. Various systems and processes according to certain embodiments of the present invention seek to address the problems mentioned above by providing a fan that is generally aligned with the center of gravity of the aircraft and whose efflux can be directed through the bottom surface of the aircraft for vertical flight and ducted aft through a propulsion duct for forward flight. Some of the fan efflux and/or some or all of the engine efflux can be provided to a vectoring unit located away from the center of gravity, such as in or near the tail of the aircraft, for controlling yaw and slant or pitch, at least during vertical flight phases of operation.

Systems and processes according to certain embodiments of the invention provide a fan which is adapted to rotate about an axis which is generally parallel to the yaw axis of the aircraft and which is preferably, but not necessarily, generally aligned with the center of gravity of the aircraft. Accordingly, the aircraft at least according to some embodiments of the invention could be considered to be more or less “balanced” relative to the fan in vertical flight. Downstream or below the fan is a chamber which includes at least two outlets, a vertical outlet which is adapted to direct fan efflux downward from the aircraft in vertical flight and a propulsion outlet which is adapted to direct fan efflux to a propulsion duct that provides thrust for forward flight, by itself or in combination with some or all of the propulsion unit efflux. Some of the fan efflux and/or some or all of the propulsion unit efflux can be ported to the vector unit for controlling pitch and/or yaw of the aircraft, at least in vertical flight. The vertical opening may be controlled by vanes which may, in turn, be selectively controlled or controlled together to route or direct fan efflux over a range of directions corresponding to various locations of the center of gravity of the aircraft as it transitions from vertical flight to horizontal flight. As flight transitions to the horizontal mode, combinations and permutations of any or all of the following may be controlled to provide smooth and superior performance during all phases: (1) power to the fan and operation of the fan; (2) quantity and direction of efflux through the vertical opening; (3) quantity of fan efflux through the propulsion duct; (4) propulsion unit efflux through the vector unit; and (5) propulsion unit efflux aft through the propulsion duct or routed as otherwise desired. For example, in vertical flight, the fan may be fully powered and fan efflux routed as desired through the vertical opening, while the vector unit is fed efflux from the propulsion unit for attitude control. In horizontal flight, the vertical outlet may be closed off, and fan efflux fed to the propulsion duct. The propulsion unit efflux can also contribute to forward thrust, either through the propulsion duct, other ducting or diversion, or according to any other desired implementation. Aerodynamic surfaces may be interposed controllably to close off access to the fan inlet, vertical outlet and surfaces of the vector unit, if desired, for cleaner aerodynamic performance.

According to the first embodiment of the invention there is provided a lift and propulsion system for an aircraft, the aircraft including a yaw axis, a pitch axis and a roll axis, a bottom surface and a top surface, comprising:

a. a fan powered by a propulsion unit, the fan adapted to rotate essentially about an axis parallel to the yaw axis of the aircraft;

b. a fan efflux chamber, said chamber including a vertical outlet adapted to direct fan efflux through an opening in the bottom surface of the aircraft and a control outlet adapted to direct fan efflux to a propulsion duct;

c. the vertical outlet communicating with a plurality of vertical outlet vanes, the vertical outlet vanes adapted to be positioned in at least three configurations:
1. a first configuration whereby at least one of the vertical outlet vanes direct fan efflux in a direction that corresponds generally to a first moment about a center of gravity of the aircraft;
2. a second configuration whereby at least one of the vertical outlet vanes direct fan efflux in a direction that corresponds generally to a second moment about a center of gravity of the aircraft; and
3. a third configuration whereby at least some of the fan efflux is routed into the propulsion duct.

According to another embodiment of the invention, there is provided a lift and propulsion system for an aircraft, the aircraft including a yaw axis, a pitch axis, a roll axis, and a tail, the system comprising a fan powered by a propulsion unit, a propulsion duct communicating with the fan, and a vectoring unit communicating with the propulsion unit, the vectoring unit located substantially in the tail of the aircraft, wherein the vectoring unit includes:
a. a plurality of pitch vanes, adapted to be controlled by the pilot to direct efflux from the propulsion unit in a direction which causes the aircraft to change its orientation relative to the pitch axis; and
b. a plurality of yaw vanes adapted to be controlled by the pilot to direct efflux from the propulsion unit in a direction which causes the aircraft to change its orientation relative to the yaw axis.

According to another embodiment of the invention, there is provided a lift and propulsion system for an aircraft, the aircraft including a yaw axis, a pitch axis and a roll axis, a bottom surface, a top surface and a tail, comprising:

a. a fan powered by a propulsion unit, the fan adapted to rotate essentially about an axis parallel to the yaw axis of the aircraft;

b. a fan efflux chamber, said chamber including a vertical outlet adapted to direct fan efflux through an opening in the bottom surface of the aircraft and a control outlet adapted to direct fan efflux to a propulsion duct;

c. the vertical outlet communicating with a plurality of vertical outlet vanes, the vertical outlet vanes adapted to be positioned in at least three configurations:
1. a first configuration whereby at least one of the vertical outlet vanes direct fan efflux in a direction that corresponds generally to a first moment about a center of gravity of the aircraft;
2. a second configuration whereby at least one of the vertical outlet vanes direct fan efflux in a direction that corresponds generally to a second moment about a center of gravity of the aircraft; and
3. a third configuration whereby at least one of the vertical outlet vanes direct fan efflux into the propulsion duct; and

d. a vectoring unit communicating with the propulsion unit, the vectoring unit located substantially in the tail of the aircraft, wherein the vectoring unit includes:
1. a plurality of pitch vanes, adapted to be controlled by the pilot to direct efflux from the propulsion unit in a direction which causes the aircraft to change its orientation relative to the pitch axis; and
2. a plurality of yaw vanes adapted to be controlled by the pilot to direct efflux from the propulsion unit in a direction which causes the aircraft to change its orientation relative to the yaw axis.

### BRIEF DESCRIPTION

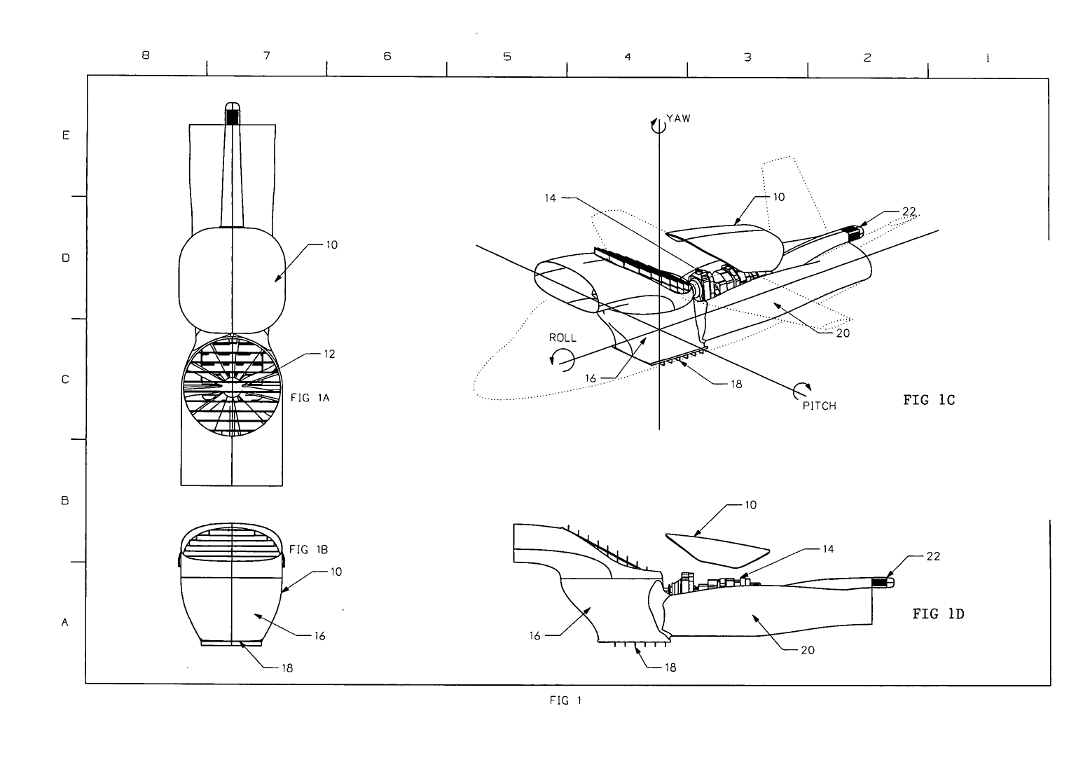

FIGS. 1 A-D show respectively, a top plan, front elevational, perspective and side elevational view of a preferred embodiment of systems according to one aspect of the invention.

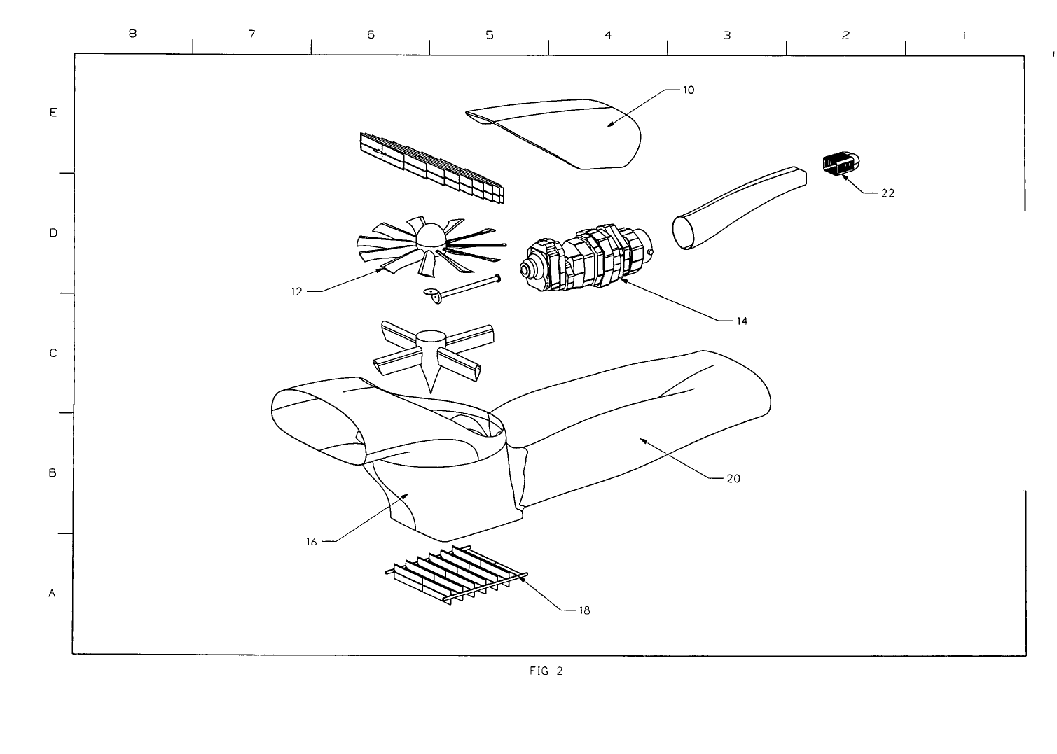

FIG. 2 shows an exploded view of the system of FIG. 1.

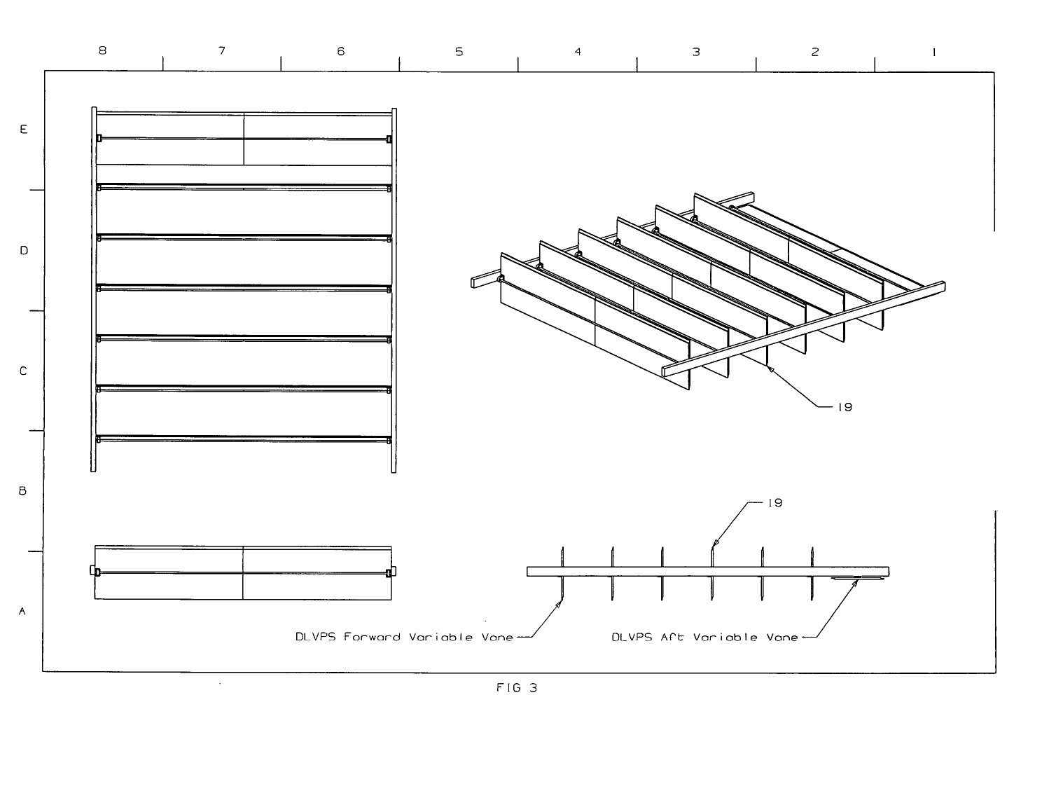

FIG. 3 shows a particular embodiment of a vane unit for controlling fan efflux through a vertical opening in the FIG. 1 system.

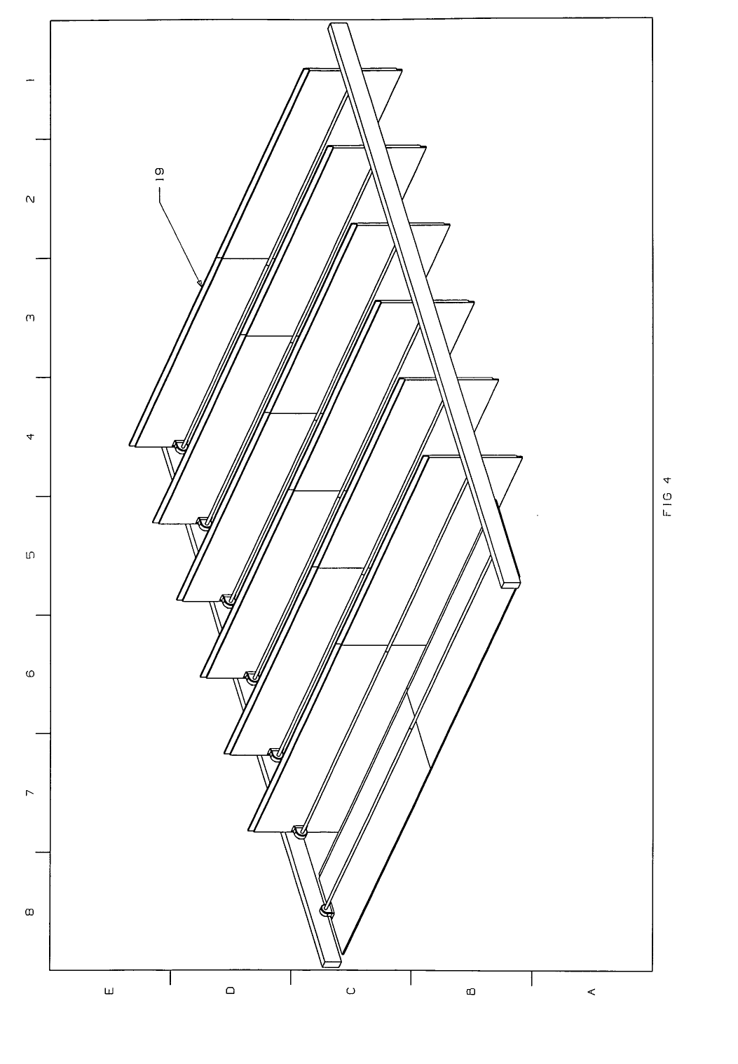

FIG. 4 shows the vanes of FIG. 3 configured to direct downward thrust a first general direction.

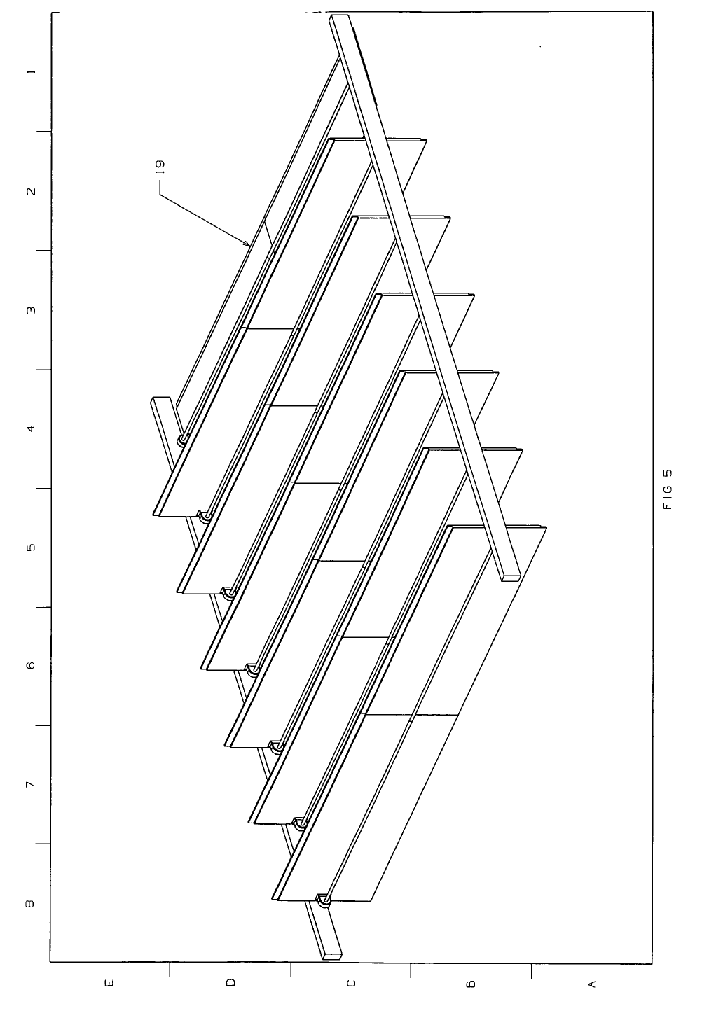

FIG. 5 shows the vanes of FIG. 3 configured to direct thrust in a second or other general downward direction.

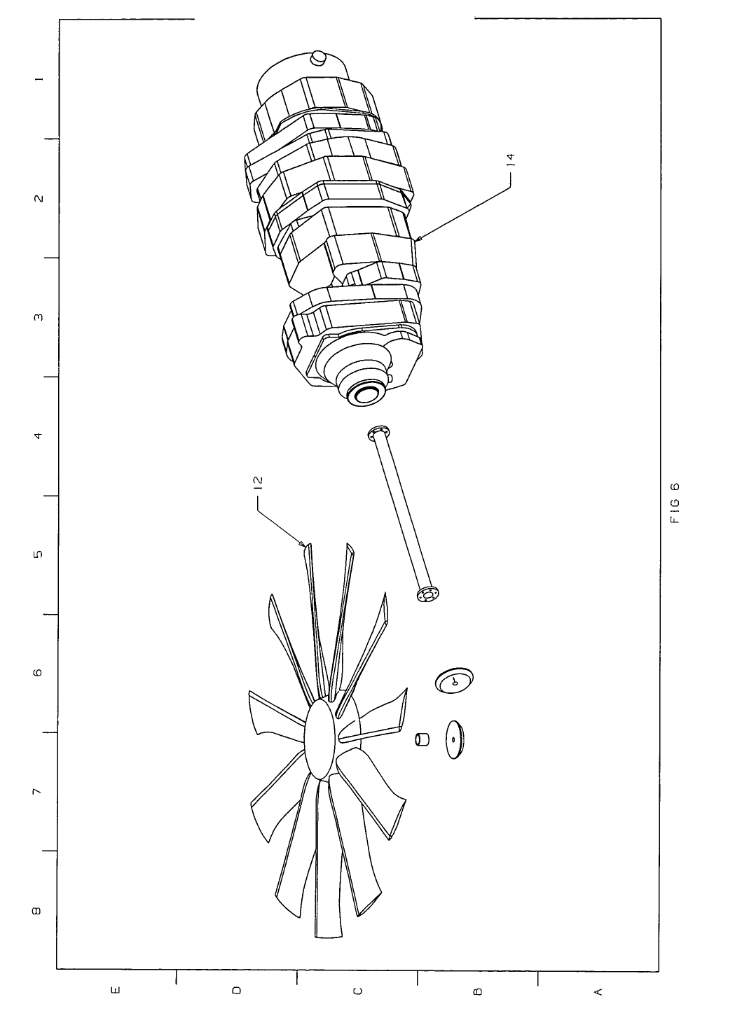

FIG. 6 shows a propulsion unit in the form of a turboshaft engine coupled to a fan in accordance with the FIG. 1 system.

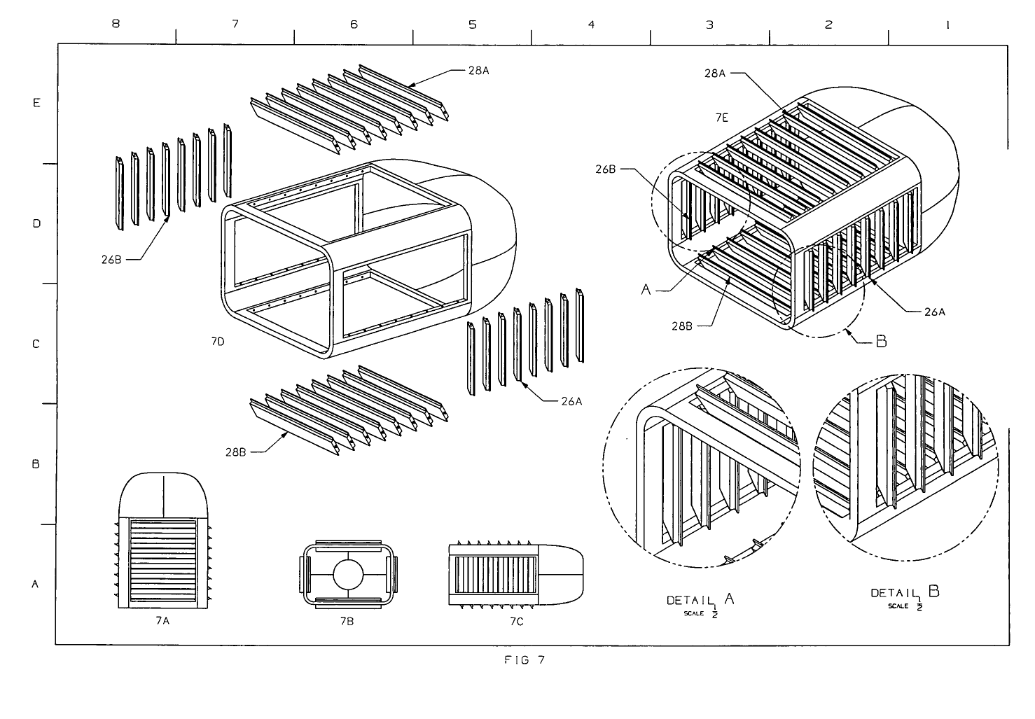

FIG. 7 shows the particular version of a vector unit for controlling pitch and yaw of the system of FIG. 1.

### DETAILED DESCRIPTION

FIGS. 1 A-D show a preferred embodiment of systems according to one aspect of the invention for propelling and controlling attitude of an aircraft. As shown in these figures, system 10 comprises a fan 12 which is coupled to a propulsion unit 14. The fan is preferably oriented so that it rotates about an axis substantially parallel to the yaw axis of the aircraft. The fan is also preferably but not necessarily located so that its rotational axis contains or is near, or generally aligned with, the aerodynamic center or center of gravity of the aircraft throughout a desirable part of at least the vertical flight envelope. Fan 12 may contain fixed pitch or controllably variable pitch vanes or blades as desired. Fan 12 is preferably coupled to a propulsion unit 14 which may be a high specific energy turbo shaft engine which can be mounted, but need not be, so that its output shaft or turbine shaft is oriented generally parallel to the roll axis of the aircraft. In this manner, thrust from the propulsion unit may be directed aft, including directly or at least some portion through the propulsion duct for forward thrust in horizontal flight mode. Some or all efflux from the propulsion unit can also be supplied to the vectoring unit as desired for attitude control at least in vertical flight phases. The propulsion unit 14 may be mounted aft of the fan 12 so that the aircraft may be “balanced” in vertical flight on the fan 12 axis as the weight of the propulsion unit 14 and fuel, as an example, offset the weight of the pilot and other passengers or cargo which may be located forward of the fan 12. “Below,” or located toward a bottom or lower surface of the aircraft from the fan, is a chamber 16 which receives fan efflux and routes it to a vertical outlet 18 which penetrates the bottom surface of the aircraft and to a propulsion duct 20 which proceeds aft to vector unit 22. The amount of and direction of flow of efflux through the vertical outlet 18 may be controlled as discussed below and efflux to the propulsion duct 20 may also be controlled by one or more vanes or other structure interposed between the efflux chamber 16 and the vertical outlet 18 and propulsion duct 20 or in portions of either of them. Vanes in the inlet structure upstream of the fan may also be controlled for various purposes as desired.

FIG. 2 shows the components of FIG. 1 in exploded view.

FIG. 3 shows a vane unit for use in a vertical outlet 18 of the system of FIG. 1. As shown in FIG. 3 a plurality of vanes 19 are adapted to be rotated, either individually or collectively, about an axis which can be generally parallel to the pitch axis of the aircraft. The vanes 19 may be controlled either in unison or selectively to direct thrust more in a forward direction as shown with the configuration in FIG. 3 or more in an aft direction as shown with the configuration in FIG. 4, either under manual control or automatic control for vertical flight modes. Vanes can also be provided, if desired, to direct thrust to the port or starboard, as desired, for control about the roll axis. As an alternative to closing off vanes 19 as shown on those figures, one or more vanes 10 may be angled at an orientation other than purely vertical or horizontal to achieve such purposes. For example, one or more of the vanes may be angled a certain number of degrees forward to deflect efflux more forward from vertical outlet 18. Similarly, the vanes 19 may be deflected at any other desired angle in an opposite direction to deflect efflux more aft from vertical outlet 18. FIG. 5 shows the same orientation of vanes as reflected in FIG. 3. In this way, control of the vanes creates moments about the pitch axis of the aircraft, as desired, and also about the roll axis if desired to allow for stability and control of the aircraft in at least vertical flight modes.

FIG. 6 shows one coupling of a high specific power turbo shaft engine according to the embodiment of the system shown in FIG. 1 to the fan 12.

FIG. 7 shows the vector unit 22 of the system of FIG. 1 in greater detail. Vector unit 22, which, in the embodiment shown in FIG. 1, is provided with efflux directed from the propulsion unit 14, at least during vertical flight, includes a number of yaw vanes 26 and pitch vanes 28. These vanes may be selectively actuated to control attitude of the aircraft about its yaw and pitch axis. For example, to initiate a port turn, yaw vanes 26A could be actuated to allow greater flow of efflux to the port side of the aircraft than through yaw vanes 26B to starboard. Thus, similar to the tail rotor on a helicopter, the thrust provided in a port direction swings the nose of the aircraft in a port direction about the yaw axis. Conversely, allowing greater flow of efflux through vanes 26B can be employed to help turn the aircraft in a starboard direction about its yaw axis. Pitch vanes 28 can operate in a similar manner, so that allowing more efflux through vanes 28A pitches the nose of the aircraft up about its pitch axis and allowing more flow through vanes 28B pitches the nose down about the pitch axis. Efflux to the vector unit 22 may be provided directly from the exhaust of the propulsion unit 14 as suggested in these figures, at least during vertical flight. Vectoring unit 22 could also receive some or all of its efflux flow from propulsion duct 20. In horizontal flight, efflux from the engine can be routed into the propulsion duct 20 where the fan efflux is also routed to provide aft thrust for horizontal flight.

In the system shown in FIG. 1, efflux from efflux chamber 16 in horizontal flight mode is routed directly to propulsion duct 20 by closing off vertical outlet vanes 24 and vertical outlet 18 so that the fan efflux proceeds aft and provides forward thrust for the aircraft. (Some of it can be bled off, or some of the engine efflux can be bled off, to ports on the wings or at other locations preferably away from the roll axis of the aircraft for roll control, if desired; alternatively, or in combination, additional vertical outlet vanes can be provided to direct efflux in port or starboard directions thereby to impart desired moments about the roll axis of the aircraft.) Efflux from the propulsion unit 14 can also be routed to the propulsion duct 20 in the horizontal forward flight mode.

Systems and processes according to various embodiments of the invention can be employed in any desired size or configuration of aircraft and combined with other systems in conventional or unconventional fashion to control the roll of the aircraft either by ducting efflux to locations port and starboard of the roll axis, or providing other roll control means for vertical flight or otherwise. Such systems can be used in aircraft that are particularly well suited for emergency evacuations such as for use by hospitals and medical emergency facilities and applications where minimum takeoff space is available but speed and range are often important to convey passengers in critical condition to the optimum medical facility quickly. Such systems may also be used in remotely-piloted vehicles where there is no available takeoff space but RPV surveillance and/or weapons deployment capability is desired. Systems according to the invention can also be employed in general aviation aircraft for use by individuals who do not live close to an airport facility but would nevertheless desire to own an aircraft which requires no takeoff space but which features a horizontal flight, performance characteristics generally commensurate with conventional general aviation fixed-wing aircraft.

Various changes, additions, deletions and modifications may be made to the systems disclosed in this document without departing from the scope or spirit of the invention.

What is claimed is:

1. A lift and propulsion system for an aircraft, the aircraft including a yaw axis, a pitch axis and a roll axis, a bottom surface and a top surface, comprising:
a. a fan powered by a propulsion unit, the fan adapted to rotate essentially about an axis parallel to the yaw axis of the aircraft;
b. a fan efflux chamber, said chamber including a vertical outlet adapted to direct fan efflux through an opening in the bottom surface of the aircraft and a control outlet adapted to direct fan efflux to a propulsion duct;
c. the vertical outlet communicating with a plurality of vertical outlet vanes, the vertical outlet vanes adapted to be positioned in at least three configurations:
a first configuration whereby at least one of the vertical outlet vanes direct fan efflux in a direction that corresponds generally to a first moment about a center of gravity of the aircraft;
2. a second configuration whereby at least one of the vertical outlet vanes direct fan efflux in a direction that corresponds generally to a second moment about a center of gravity of the aircraft; and
3. a third configuration whereby at least some of the fan efflux is routed into the propulsion duct.

2. A system according to claim 1 wherein the fan includes a plurality of blades with fixed pitch.

3. A system according to claim 1 wherein the fan includes a plurality of blades with variable pitch.

4. A system according to claim 1 wherein the propulsion unit is a turboshaft engine which is geared to the fan.

5. A system according to claim 4 wherein the rotational axis of at least one turbine shaft in the engine is oriented substantially parallel to the roll axis of the aircraft.

6. A system according to claim 5 wherein the engine is mounted in the aircraft aft of the fan.

7. A system according to claim 4 wherein the fan efflux chamber does not receive efflux from the engine.

8. A system according to claim 4 wherein the propulsion duct receives efflux from the engine.

9. A system according to claim 1 wherein the fan rotates about an axis that passes generally through the center of gravity of the aircraft.

10. The system according to claim 1 wherein the system is mounted in an aircraft, and comprising the aircraft.

11. A lift and propulsion system for an aircraft, the aircraft including a yaw axis, a pitch axis, a roll axis, and a tail, the system comprising a fan powered by a propulsion unit, a propulsion duct communicating with the fan, and a vectoring unit communicating with the propulsion unit, the vectoring unit located substantially in the tail of the aircraft, wherein the vectoring unit includes:
a. a plurality of pitch vanes, adapted to be controlled by the pilot to direct efflux from the propulsion unit in a direction which causes the aircraft to change its orientation relative to the pitch axis; and
b. a plurality of yaw vanes adapted to be controlled by the pilot to direct efflux from the propulsion unit in a direction which causes the aircraft to change its orientation relative to the yaw axis.

12. A system according to claim 11 wherein the fan is adapted to rotate essentially about an axis that is parallel to the yaw axis of the aircraft.

13. A system according to claim 11 wherein the propulsion unit is located in the aircraft aft of the fan and comprises a turboshaft engine.

14. A system according to claim 13 wherein the propulsion unit comprises a turboshaft engine whose turbine shaft is oriented essentially parallel to the roll axis of the aircraft.

15. A system according to claim 11 wherein the pitch vanes are rotatable on an axis substantially parallel to the pitch axis of the aircraft.

16. A system according to claim 11 wherein the yaw vanes are rotatable on an axis substantially parallel to the yaw axis of the aircraft.

17. A system according to claim 14 wherein the propulsion duct receives efflux from the turboshaft engine as well as from the fan.

18. A system according to claim 11 wherein the system is mounted in an aircraft, and further comprising the aircraft.

19. A lift and propulsion system for an aircraft, the aircraft including a yaw axis, a pitch axis and a roll axis, a bottom surface, a top surface and a tail, comprising:
a. a fan powered by a propulsion unit, the fan adapted to rotate essentially about an axis parallel to the yaw axis of the aircraft;
b. a fan efflux chamber, said chamber including a vertical outlet adapted to direct fan efflux through an opening in the bottom surface of the aircraft and a control outlet adapted to direct fan efflux to a propulsion duct;
c. the vertical outlet communicating with a plurality of vertical outlet vanes, the vertical outlet vanes adapted to be positioned in at least three configurations:
1. a first configuration whereby at least one of the vertical outlet vanes direct fan efflux in a direction that corresponds generally to a first moment about a center of gravity of the aircraft;
2. a second configuration whereby at least one of the vertical outlet vanes direct fan efflux in a direction that corresponds generally to a second moment about a center of gravity of the aircraft; and
3. a third configuration whereby at least some fan efflux is routed into the propulsion duct; and
d. a vectoring unit communicating with the propulsion unit, the vectoring unit located substantially in the tail of the aircraft, wherein the vectoring unit includes:
a. a plurality of pitch vanes, adapted to be controlled by the pilot to direct efflux from the propulsion unit in a direction which causes the aircraft to change its orientation relative to the pitch axis; and
b. a plurality of yaw vanes adapted to be controlled by the pilot to direct efflux from the propulsion unit in a direction which causes the aircraft to change its orientation relative to the yaw axis.

20. A system according to claim 19 wherein the propulsion unit comprises a turboshaft engine and the rotational axis of at least one turbine shaft in the engine is oriented substantially parallel to the roll axis of the aircraft.

21. A system according to claim 19 wherein the fan efflux chamber does not receive efflux from the engine.

22. A system according to claim 20 wherein the engine is mounted in the aircraft aft of the fan.

23. A system according to claim 20 wherein the propulsion duct receives efflux from the engine.

24. A system according to claim 19 wherein the pitch vanes are rotatable on an axis substantially parallel to the pitch axis of the aircraft.

25. A system according to claim 19 wherein the yaw vanes are rotatable on an axis substantially parallel to the yaw axis of the aircraft.
